(19) United States
(12) Patent Application Publication
(10) Pub. No.: US 2018/0295849 A1
(43) Pub. Date: Oct. 18, 2018

(54) PLANT-BASED MILK ALTERNATIVE COMPOSITION AND METHOD

(71) Applicant: Hakuna Foods LLC, Nashville, TN (US)

(72) Inventors: David Earl, Nashville, TN (US); Eric Hyde, Nashville, TN (US)

(21) Appl. No.: 15/952,747

(22) Filed: Apr. 13, 2018

Related U.S. Application Data
(60) Provisional application No. 62/485,102, filed on Apr. 13, 2017.

(51) Int. Cl. A23C 11/10; A23G 1/56; A23G 1/48; A23G 9/42; A23G 9/38

(52) U.S. Cl. CPC A23C 11/106; A23C 11/103; A23G 1/56; A23V 2002/00; A23G 9/42; A23G 9/38; A23G 1/48

(57) ABSTRACT

A plant-based milk alternative composition useful in various food and beverage products that approximates the nutritional and functional properties of dairy milk but does not contain dairy or lactose.

### CROSS-REFERENCE TO RELATED APPLICATION

The present application claims priority benefit of U.S. Provisional Application No. 62/485,102, filed Apr. 13, 2017, which is herein incorporated by reference in its entirety.

### BACKGROUND OF THE INVENTION

Dairy milk products play a critical role in human and animal diets globally due to their ideal nutritional composition of proteins, fats and carbohydrates. While the largest source of milk products remains dairy milk, there is a growing demand for plant-based (i.e., plant-derived) milk alternatives for allergenic, consumer preference, and ecological reasons.

Dairy milk remains predominant in nutrition and cooking applications because of its qualities of aeration, viscosity, moisturization/tenderization, and specific heat (impacting dairy milk's crystallization properties). Aeration is the incorporation of air into a liquid. It is important because it allows milk to be whipped into cream. It is also important for frothing and steaming milk. The aeration properties of milk result from the fatty acids in milk forming micelles (discussed below) filled with air. Viscosity is how tightly a liquid holds together. The viscosity of milk is a result, among other things, of the ratio of unsaturated to saturated fatty acids. Tenderization/moisturization is the texture and mouthfeel provided by milk. This quality prevents dry dough during baking, keeps gluten from becoming too structured in breads, and makes the solution feel hydrating when consumed. Specific heat is the ability of a substance to absorb heat, which impacts the substance's crystallization properties (also its solidification or coagulation) and its ability to form solid particles in response to temperature, acidity, and enzymatic activity. The crystallization properties of milk are what allows it to be frozen into ice cream. Each of these properties of dairy milk is a result of the concentration of fatty acids and their ratios in dairy milk. Dairy milk has a density of about 1.035 kg/L. Dairy milk has a viscosity of about 0.002 Pa s (pascal-second) at 20° C., 0.003 Pa s at 4° C., and 0.0005 Pa s at 80° C. Dairy milk has a moisturization of about 87% water by weight. Dairy milk has a freezing point of about −0.5° C.

Dairy milk forms micelles, which is essentially a balloon or bubble formed by water and hydrophobic solutes. In a double-walled micelle, the water is sandwiched entirely between two layers of lipids. The hydrophilic end of the lipids arranges next to the water molecules (in a double-walled micelle, both inside and outside the bubble) with the hydrophobic ends of the lipids facing away from the bubble of water molecules toward the inside of the bubble and away from the outside of the bubble. As shown in FIG. 3, these micelles are formed as water bubbles, the bubbles formed of water walls lined inside and outside with lipids. Because the bubbles are lined with lipids on the inside, they can hold other substances within the bubbles. FIG. 4 shows micelles filled with oil or air. When a micelle is filled with oil, it is called an emulsion. When a micelle is filled with air, it is called foam. Dairy milk's unique ability to emulsify and foam is one of its prized characteristics as a food.

Several methods are known for producing milk alternatives from plant sources. The most common milk alternatives are soy, coconut, rice, oat, almond and other tree-nut based milk alternatives. Known methods for producing these alternatives vary drastically in their processes with some utilizing the whole plant and others just the seed material as their starting material. Some require extensive processing to yield an aqueous or colloidal extract from those source materials. Other methods broadly consist of reconstituting mixtures of isolated and purified macro-nutrients in dry or liquid form.

In addition to their use as nutritional beverages, plant-based milk alternatives can also be used to produce non-dairy creamers, non-dairy yogurts, non-dairy frozen desserts and other food products that traditionally require a dairy milk product base. However, these plant-based milk alternatives have inferior thermodynamic, tensile, surfactant, and aerification properties and, as a result, dairy milk remains the preferred primary ingredient for many food products, including frozen desserts, creamers, and yogurts.

The preferred functional properties of dairy milk arise from its chemical composition, especially its fatty acid content and composition. While variations in bovine breed, feed, production season and production geography result in slight changes in the resulting dairy milk compositions, a typical dairy milk composition is 3.9% fat, 3.25% protein, 4.6% carbohydrates, 87.3% water and less than 1% of other solids (primarily minerals and vitamins). In another example of dairy milk, the overall composition per 8 oz. serving (227 g) is 3.5% fat, 5.3% carbohydrates, and 3.5% protein. Additionally, the fat profile of dairy milk is approximately 58% long chain fatty acids, 21% medium chain fatty acids, and 17% short chain fatty acids. The lipid content of dairy milk is generally about 2% saturated fatty acids, 0.22% polyunsaturated fatty acids, and 0.88% monounsaturated fatty acids, for a total of about 3% total fatty acids. Specifically, the fatty acid composition of dairy milk is approximately 10% myristic, 23% palmitic, 10% stearic, 29% oleic, 3% capric, 3% lauric, 2% linoleic, <1% linolenic, 1% caprylic, 5% caproic, and 11% butyric acid. See FIG. 5. The remaining lipid components (3%) comprise diaclyglycerides, monoaclyglycerides, phospholipids, cholesterol, and glycolipids.

As shown in FIG. 6, the unsaturated fatty acids in dairy milk have “kinks” in their carbon chains so they do not pack tightly together. This allows them to remain liquid at lower temperatures than saturated fatty acids that have straight carbon chains. The ratio and concentration of unsaturated fatty acids and saturated fatty acids is important to the particular characteristics of dairy milk during heating and cooling because they affect its freezing and melting points. For example, dairy milk is liquid at room temperature, has a boiling point of 100.5° C., solidifies at −0.5° C., and has a specific heat of 0.93 kcal/kg ° C.

The major protein in dairy milk is casein, and the minor protein is whey. The carbohydrate profile of dairy milk is about 95% lactose.

Regardless of the production method, current plant-based milk-alternative products typically range in composition from less than 0.5% by total weight protein to about 4% by total weight protein; from less than 0.5% by total weight fat to about 2.5% by total weight in fat; and from less than 0.5% by total weight of carbohydrates to about 5% by total weight of carbohydrates. These products have a much lower percentage by weight of fatty acids than dairy milk, which results in their having different characteristics than dairy milk.

The present application discloses a composition of protein, carbohydrates, and fatty acids made from plant sources that mimics the functional properties of dairy milk, regardless of the starting source material, by mimicking the concentrations and ratios of saturated and unsaturated fatty acids and the approximate fatty acid proportions of dairy milk using fatty acids derived from plant materials. In one embodiment, the present disclosure is of a composition and its method of production that is about 3% fat, 5.3% carbohydrate, and 3% protein. In one embodiment, the present disclosure is of a composition and its method of production that is 2% saturated fatty acids, 0.2% polyunsaturated fatty acids, and 0.66% monounsaturated fatty acids.

### SUMMARY OF THE INVENTION

The present invention is a plant-based milk alternative base composition for use in preparing food and beverage products and method for making it, specifically for products that require the unique and desirable nutritional and functional properties of dairy milk without originating from dairy products or animal products.

One aspect of the present invention is a liquid composition containing between about 2.5% to 7% by weight of plant-based fats; between about 1% and 10% by weight plant-based carbohydrates; and between about 0.025% and 7% by weight of plant-based proteins. These ranges of macronutrients more closely approximate the ranges found in dairy milk than other available plant-based milk alternatives.

Another aspect of the present disclosure is the approximate ratio of fatty acid components and their plant derived sources. In one embodiment, the present plant-based composition comprises between about 60 to 90 parts long chain fatty acids, about 10 to 40 parts medium chain fatty acids, and about 5 to 20 parts short chain fatty acids. In another embodiment, the present plant-based composition comprises between about 50 to 75 parts long chain fatty acids, about 25 to 40 parts medium chain fatty acids, and about 5 to 10 parts short chain fatty acids. These ratios of fatty acids approximate the fatty acid composition found in dairy milk and improve the functional characteristics of the resulting plant-based liquid composition. Another aspect of an embodiment of the present disclosure is a plant-based liquid composition comprising a ratio of between about 50 to 80 parts saturated fatty acids to about 20 to 50 unsaturated fatty acids. Yet another aspect of the present disclosure is a total liquid composition that is about 84 to 90 parts water.

Yet another aspect of the present disclosure is to supplement the plant-based liquid composition with protein. In one aspect of the present disclosure, plant-based protein comprises between about 0.025% and 7% by weight. In one example, chickpeas are used as a protein source because of their relatively high protein content and the low incidence of allergies to chickpeas in the general population. In one embodiment, the disclosed plant-based liquid composition comprises chickpea protein of about 2.5% to 3.5% by weight.

Yet another aspect of the present disclosure is to supplement the plant-based liquid composition with emulsifiers, stabilizers, flavorings, vitamins and mineral salts to maintain an even colloidal suspension and provide flavor and nutritional profiles suitable for various food and beverage products. In one embodiment, the fatty acid chains, emulsifiers, stabilizers, flavoring, vitamins, and mineral salts can be synthetic or from non-plant-based origins.

The present invention may further comprise dehydrating the above liquid compositions and subsequent reconstitution.

### BRIEF DESCRIPTION OF DRAWINGS

FIG. 1 is a diagram of the method and equipment required to make the disclosed compound, in one embodiment.

FIG. 2 is a flow chart of the steps for making the disclosed compound, in one embodiment.

FIG. 3 is a drawing of a double-walled micelle.

FIG. 4 is a drawing of foam and emulsion micelles.

FIG. 5 is a drawing showing the structures of fatty acids.

FIG. 6 is a drawing of how saturated fatty acids and unsaturated fatty acids pack together.

### DETAILED DESCRIPTION OF THE PREFERRED EMBODIMENT(S)

In one example composition, plant-based oils are selected based on their fatty acid compositions so that the fatty acid composition of the resulting composition by weight is approximately 9% myristic, 23% palmitic, 5% stearic, 26% oleic, 4% capric, 22% lauric, 3% linoleic, <1% linolenic, 3% caprylic, and 0.25% caproic acid. This represents about 57% long chain fatty acids to 40% medium chain fatty acids to about <1% short chain fatty acids. This also represents a fatty acid profile of about 30% unsaturated fatty acids and 70% saturated fatty acids.

In one example composition, the long chain fatty acids and medium chain fatty acids are derived from one of the following plant-based oils: palm and coconut. In one example composition, the composition has a moisturization of about 84% to 90% water. In one example composition, the composition has a viscosity of about 0.002 Pa s at 20° C. In one example composition, the composition has a specific heat of between about 0.92 to 0.94 kcal/kg ° C. In one example composition, the composition is liquid at room temperature, has a boiling point of between about 99° C. and 101° C. and a melting point between about −1° C. and 0° C. In one example composition, emulsifiers are added for stability of the emulsion.

In one example of selection of plant-based materials, several plant-based materials are selected for the concentration of oils containing medium and long chain fatty acids. As shown in Table 1 below, Coconut oil can be a source of medium chain fatty acids, but sunflower, almond, and palm oils are generally not (except that palm oil contains myristric acid). By contrast, as shown in Table 2, long-chain fatty acids are found in all of sunflower, almond, palm, and coconut oil. Table 3 shows the percentages of all medium and long chain fatty acids in these common plant-based materials.

TABLE 1
Percentages of Fatty Acids of Medium Chain
Length in Dairy and Common Plant Sources

| Lipid | % | | | | |
|---|---|---|---|---|---|
| Source | Caproic | % Caprylic | % Capric | % Lauric | % Myristic |
| Dairy | 5 | 1 | 3 | 4 | 10 |
| Sunflower | 0 | 0 | 0 | 0 | 0 |
| Almond | 0 | 0 | 0 | 0 | 0 |
| Coconut | 0.5 | 7 | 8 | 45 | 16 |
| Palm | 0 | 0 | 0 | 0 | 2 |

TABLE 2
Percentages of Fatty Acids of Long Chain
Length in Dairy and Common Plant Sources

| Lipid | % | | | | |
|---|---|---|---|---|---|
| Source | Palmitic | % Palmitoleic | % Stearic | % Oleic | % Linoleic |
| Dairy | 23 | 0 | 10 | 29 | 10 |
| Sunflower | 4 | 0 | 3 | 30 | 60 |
| Almond | 5 | 0.5 | 2 | 70 | 20 |
| Coconut | 9.5 | 0 | 2 | 6.5 | 0.5 |
| Palm | 37 | 0 | 7 | 45 | 6 |

TABLE 3
Total Percentages of Fatty Acids
of Medium and Long Chain Length

| Lipid Source | % Medium | % Long |
|---|---|---|
| Dairy | 23 | 64.5 |
| Sunflower | 0 | 97 |
| Almond | 0 | 97.5 |
| Coconut | 76.5 | 18.5 |
| Palm | 2 | 95 |

The most important fatty acids contributing to the taste of dairy milk are short chain fatty acids because of their relative volatility compared to medium and long chain fatty acids. Unfortunately, these short chain fatty acids are uncommon in significant quantities in plant-based materials. However, flavor additives can be used to overcome this shortcoming in plant-based dairy products.

By contrast, the most important fatty acids contributing to the aeration, viscosity, and specific heat of dairy milk are medium and long chain fatty acids. Unlike short chain fatty acids, medium and long chain fatty acids can be found in certain plants and plant oils, such as palm oil, coconut oil, almond oil, and sunflower oil (and others, but these are the most commercially available plant oils). One difficulty in using plant-based materials as a source of medium and long chain fatty acids is that the proportion of medium and long chain fatty acids in these plant-based materials is very different than in dairy milk. Of the medium chain fatty acids, lauric and myristic acid contribute the most to viscosity and specific heat of dairy milk because of the ability of the saturated fatty acid chains to pack tightly in a liquid next to long chain fatty acids. In general, the longer the chain, the more a fatty acid will contribute to viscosity and specific heat. Of the long chain fatty acids, palmitic and stearic acids are important because they also pack tightly together with lauric and myristic acid in solution.

Dairy milk has approximately a 1:3 ratio of medium chain to long chain fatty acids (about 23% to 64.5%), but with an overall percentage fatty acid by weight of 3.5% and water of 87%. Said a different way, the target plant-based substance should have a water content of about 87% by weight, a total fatty acid content of about 3.5% by weight, and a ratio of about 1:3 medium chain to long chain fatty acids. The closer the viscosity and specific heat of the plant-based milk to dairy milk, the better substitute it will be to dairy milk in many applications. A person having ordinary skill in the art will appreciate that these ratios and percentages are on a gradient. In one example, a composition can have a total fatty acid content by weight of between about 3% to 5% total fatty acids, a total water content by weight of between about 84% to 90%, and a ratio of medium chain fatty acids to long chain fatty acids of between about 1:1.25 and 1:4. In one embodiment, the ratio of medium chain fatty acids to long chain fatty acids is about 1:1.4.

In addition to the length of the fatty acid chain, the saturation of the fatty acids also contributes to the viscosity and specific heat of dairy milk and milk substitutes. As to aeration, generally speaking, the more saturated fatty acids present, the better aeration the substance will have; provided, however, that if the ratio of saturated chains to unsaturated fatty acids exceeds about 1:1, then the substance will have a decreased viscosity. Dairy milk has a ratio of unsaturated to saturated fatty acids of about 1:1.8. A person having ordinary skill in the art will appreciate that these ratios and percentages are on a gradient. In one example, a composition can have a total fatty acid content by weight of between about 3% and 5% total fatty acids, a total water content by weight of between about 84% to 90%, and a ratio of unsaturated fatty acids to saturated fatty acids of between about 1:1.5 and 1:2.5. In one embodiment, the ratio of unsaturated fatty acids to saturated fatty acids is about 1:2.3. Table 4 shows the general composition of saturated and unsaturated fatty acids in dairy milk and several common plant-based oils.

TABLE 4
Total Percentages of Fatty Acid Saturation Type

| Lipid Source | % Saturated | % Monounsaturated | % Polyunsaturated |
|---|---|---|---|
| Dairy | 63 | 32 | 5 |
| Sunflower | 8 | 31 | 61 |
| Almond | 7 | 72 | 21 |
| Coconut | 90 | 9 | 1 |
| Palm | 47 | 46 | 7 |

Additionally, in one example of selection of plant-based materials, several plant-based materials are selected for the concentration of oils containing unsaturated and saturated fatty acids. In one example of selection of plant-based materials, several plant-based materials are selected from the group of oils shown in Table 4 in quantities and combinations that add up to total composition having between about 0.5% to 1% by weight unsaturated fatty acids and about 1.5% to 2.5% by weight saturated fatty acids. In one example, the ratio of unsaturated fatty acids to saturated fatty acids is about 1:2.3 or between about 27% and 35% unsaturated fatty acids. In one example of selection of plant-based materials, several plant-based materials are selected from the group of oils shown in Table 4 in combinations that add up to a total composition having a maximum of about 3.5% by weight fatty acids and of that total, between about 0.5% to 1% unsaturated fatty acids and between about 1.5% to 2.5% saturated fatty acids. As shown in Table 4, sunflower oil is high in unsaturated fatty acids while coconut oil and palm oil are higher in saturated fatty acids. As a result, coconut oil and palm oil can be used to supplement the saturated fatty acids present in other plant-based oils. In one example, 3.5 g coconut oil and 3.5 g palm oil are added to 230 g of a chickpea-based liquid composition to obtain an overall fatty acid content of about 3% by weight and a ratio of unsaturated fatty acid to saturated fatty acid of 1:2.3 (i.e., 30% unsaturated and 70% saturated fatty acid).

In one example of selection of plant-based materials, several plant-based materials are selected from the group of oils shown in Table 4 in combinations that add up to a total fatty acid profile of between about 25% to 28% monounsaturated fatty acids, 3% to 4% polyunsaturated fatty acids, and 65% to 74% saturated fatty acids.

In one example of selection and preparation of plant-based materials, several plant-based materials are selected from plants in quantities and combinations that add up to total compositions having between about 1.5% to about 2% long chain fatty acids, about 1% to 1.5% medium chain fatty acids, and about 0% to 0.5% short chain fatty acids. In one embodiment, about 1.8% long chain fatty acids, about 1.2% medium chain fatty acids, and about ˜0.0% short chain fatty acids.

Dairy milk is approximately 3.5% by weight protein. In general, as the protein increases in a substance, the viscosity increases. However, if the protein content becomes too high, the substance becomes solid at room temperature or becomes an unstable colloidal mixture. Generally, the closer the protein composition of a liquid plant-based composition to dairy milk, the more nutritious it will be and the better substitute it will be to dairy milk in many applications. In one example, a composition can have a total protein content of between about 2.5% and 5% by weight and total water content of between about 84% to 90% by weight. In one embodiment, the protein content of the plant-based liquid is about 3% by weight. Common commercially available sources of plant-based proteins include: soy beans, chickpeas, yellow peas, rice, hemp, quinoa, almonds, and wheat.

In one embodiment, the plant-based (derived) liquid composition comprises between about 84% and 90% by weight water; between about 3% and 5% by weight plant-based fatty acids; between about 1% to 10% by weight plant-based carbohydrates; and between about 2.5% to 5% by weight plant-based proteins, and the composition is a plant-based liquid dairy milk substitute composition. In one example, the composition comprises a mixture of between about 10% and 40% medium chain fatty acids and between about 60% and 90% long-chain fatty acids. In one embodiment, the composition further comprises medium chain fatty acids and long chain fatty acids in a ratio of medium chain fatty acids to long chain fatty acids of between about 1:1.25 to 1:4. In one example, the fatty acids further comprise medium chain fatty acids and long chain fatty acids, the medium chain fatty acids further comprise between about 1% to 1.5% by weight of the liquid plant-based composition and the long chain fatty acids further comprise between about 1.5% to 2.0% by weight of the liquid plant-based composition. In one example, the composition comprises unsaturated fatty acids and saturated fatty acids in a ratio of unsaturated fatty acids to saturated fatty acids of between about 1:1.5 to 1:2.5. In one example, the composition further comprises unsaturated fatty acids and saturated fatty acids, the unsaturated fatty acids further comprising between about 0.5% to 1.0% by weight of the liquid plant-based composition and the saturated fatty acids further comprising between about 1.5% to 2.5% by weight of the liquid plant-based composition. In one example, the plant-based composition further comprises equal parts palm oil and coconut oil. In one example of the composition, the protein is derived from chickpeas. In one example of the composition, the plant-based medium chain fatty acids comprise lauric and myristic acids. In one example, the plant-based the plant-based long chain fatty acids in the composition comprise palmitic and stearic acids.

In one example of the plant-based composition disclosed, the liquid composition can be dehydrated using a spray drying or other commercially available dehydration process to remove all or about all of the water from the composition so that it can be stored, shipped, or used in different baking applications.

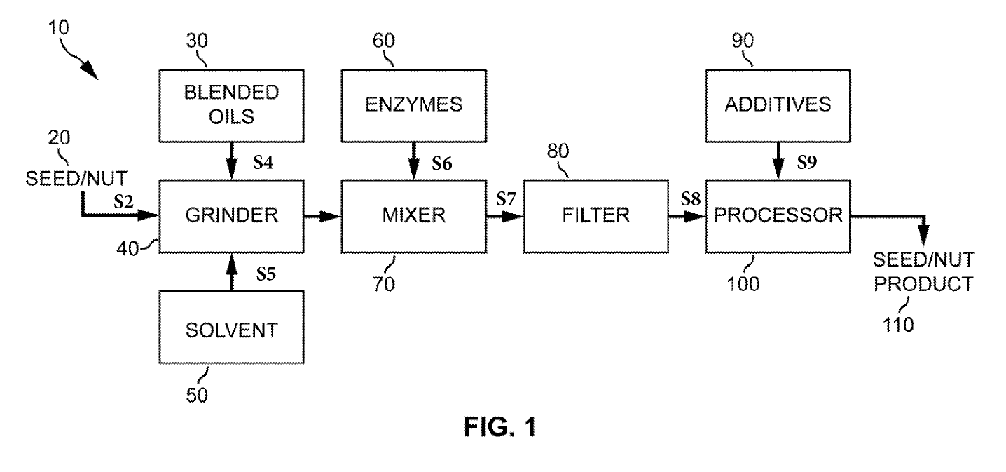

As diagramed in FIG. 1, the present disclosure comprises a system and method 10 for the preparation of plant-based materials into the disclosed compositions. Although the sequence of steps can vary, often the water and protein will be the starting materials because the protein will assist in stabilizing the oil additives in the water-based solution. The components and steps of 10 may be integrated or separated into more, fewer, or other components or steps without departing from the scope of the disclosure.

Although not shown in FIG. 1, step S1 is to rehydrate the plant-based materials, if needed. In step S2 Seed or nut derived plant materials 20 are added to a grinding or blending apparatus 40. In one application, the starting seed material 20 is dried chickpeas rehydrated in between about 15° C. and 25° C. water. In one embodiment, the chickpeas are rehydrated with between about 0.1 to 0.15 molar sodium bicarbonate for between about 6 and 8 hours before a solution of blended oils 30 is added in step S4.

Crude and refined plant oils 30 are heated to a temperature of between about 30° C. and 50° C. and mixed by gentle stirring at between about 50 and 500 rpm. In one example, about 1 part by weight of refined palm oil or refined palm kernel oil can be combined with about 1 part by weight of virgin coconut oil. Palm oil is selected because it provides long chain saturated fatty acids. Coconut oil is selected because it provides medium chain saturated fatty acids.

In step S2, the plant-based material 20 is added to a grinder or blender capable of producing a roughly milled powder. When combined with solvent 50, the mixture produces a homogenous slurry. Sufficient mechanical dissociation may be achieved by blending with a spinning metal blade at a rate of between about 1500 and 25000 rpm in a closed chamber. In one form of the method, the blended oils 30 are added in S4 to the plant-based material 20 prior or during dissociation in S7 by 40 and the final mixture is between about 20% to 30% of plant-based material 20, between about 2% to 10% of blended oils 30, and between about 60% to 80% of solvent 50 by volume.

The plant-based material 20 can be any seed or nut having harvestable protein and myristic, palmitic, stearic, oleic, capric, lauric, linoleic, caprylic, caproic, or butyric acid. Tables 5 and 6 below show common seed and nut materials that can be sources of these fatty acids. In one example of selection of fatty acids, combinations of the materials shown in tables 5 and 6 are selected.

TABLE 5
Percentages of Fatty Acids of Medium Chain Length in Plant Oils

| | | % | % | % | % |
|---|---|---|---|---|---|
| | % Caproic | Caprylic | Capric | Lauric | Myristic |
| Plant Oil | C6:0 | C8:0 | C10:0 | C12:0 | C14:0 |
| Ambadi Oil | | | | | |
| Apricot Seed Oil | | | | | 1-1.5 |
| Castor Seed Oil | | | | | |
| Chaulmoogra Oil | | | | | 0.5-1 |
| Cheru Seed Oil | | | | | |
| Coconut Oil | 0.5 | 5-9 | 5-7 | 40-50 | 13-19 |
| Corn Oil | | | | | 0-1 |
| Cotton Seed Oil | | | | | 0.5-1 |
| Dhupa Seed Oil | | | | | 0-1 |
| Hemp Seed Oil | | | | | |
| Jatropha Seed Oil | | | | | 0.5-1.4 |
| Kamala Seed Oil | | | | | |
| Kapok Oil | | | | | |
| Karanja Seed Oil | | | | | |
| Kokum Oil | | | | | 0-1.5 |
| Linseed Oil | | | | | |
| Mahua Seed Oil | | | | | |
| Mustard Seed Oil | | | | | |
| Nagkesar Seed Oil | | | | | 0-3 |
| Niger Seed Oil | | | | | 1.5-3 |
| Oiticica Oil | | | | | |
| Olive Oil | | | | | 0-1.5 |
| Palash Oil | | | | | |
| Palm Kernal Oil | | 3-5 | 3-7 | 40-52 | 14-18 |
| Palm Oil | | | | | 0.5-2 |
| Peanut Oil | | | | | |
| Perilla Oil | | | | | |
| Pilu Oil | | | 1-1.5 | 19-48 | 28-55 |
| Poppy Seed Oil | | | | | |
| Rice Bran Oil | | | | | 0.5-1 |
| Rubber Seed Oil | | | | | |
| Safflower Oil | | | | | 0-0.5 |
| Sal Seed Oil | | | | | |
| Sesame Oil | | | | | |
| Sorghum Oil | | | | | 0-1 |
| Soybean Oil | | | | | |
| Sunflower Oil | | | | | |
| Tamanu Oil | | | | | |
| Tea Seed Oil | | | | | |
| Thumba Seed Oil | | | | | |
| Tobacco Seed Oil | | | | | |
| Wheat Germ Oil | | | | | |

TABLE 6
Percentages of Fatty Acids of Long Chain Length in Plant Oils

| | % Palmitic | % Stearic | % Oleic | % Linoleic | % Linolenic |
|---|---|---|---|---|---|
| Plant Oil | C16:0 | C18:0 | C18:1 | C18:2 | C18:3 |
| Ambadi Oil | 20-35 | 2-4 | 25-34 | 15-47 | |
| Apricot Seed Oil | 3-4 | 2-4 | 72-75 | 18-22 | |
| Castor Seed Oil | 2 | 1 | 3-6 | 5 | |
| Chaulmoogra Oil | 5-12 | 1-5 | 3.5-20 | 1-2 | |
| Cheru Seed Oil | 55-60 | 3.5-4 | 30-40 | 3.5-5 | |
| Coconut Oil | 8-11 | 2-4 | 5-7.5 | 0-1 | |
| Corn Oil | 8-12 | 1.5-4 | 20-30 | 40-60 | |
| Cotton Seed Oil | 20-24 | 2-3 | 15-30 | 45-55 | |
| Dhupa Seed Oil | 9.5-13 | 38-45 | 40-48 | 0.2-3 | |
| Hemp Seed Oil | 5-7 | 1-3 | 11-13 | 54-56 | 24-26 |
| Jatropha Seed Oil | 12-20 | 5-10 | 20-25 | 19-48 | |
| Kamala Seed Oil | 7-30 | 0.5-1 | 13-20 | 10-13 | |
| Kapok Oil | 10-11 | 5-9 | 45-67 | 27-35 | |
| Karanja Seed Oil | 3.5-8 | 2-9 | 45-70 | 10-18.5 | 1-3 |
| Kokum Oil | 2-8 | 50-60 | 30-45 | 0-5 | |
| Linseed Oil | 4-7 | 2-4 | 10-30 | 12-24 | 35-60 |
| Mahua seed Oil | 15-25 | 10-20 | 40-50 | 10-15 | |
| Mustard Seed Oil | 1-3 | 1-3 | 20-25 | 15-20 | 20-30 |
| Nagkesar Seed Oil | 8-15 | 10-16 | 55-66 | 10-20 | |
| Niger Seed Oil | 4-16 | 5-10 | 13-40 | 45-66 | |
| Oiticica Oil | 6-8 | 4-6 | 5-7 | | |
| Olive Oil | 7-16 | 1-5 | 55-85 | 4-10 | 0-1.5 |
| Palash Oil | 20-30 | 7-9 | 20-30 | 30-40 | |
| Palm Kernal Oil | 7-9 | 1-3 | 11-19 | 0.5-2 | |
| Palm Oil | 32-45 | 2-7 | 35-50 | 5-11 | |
| Peanut Oil | 6-9 | 3-6 | 52-60 | 13.27 | |
| Perilla Oil | 5-8 | 1-3 | 12-20 | 13-20 | 55-65 |
| Pilu Oil | 18-30 | | 5-12 | 0-1.5 | |
| Poppy Seed Oil | 10-15 | 2-3 | 10-20 | 65-75 | 3-6 |
| Rice Bran Oil | 12-22 | 1-3 | 40-50 | 29-42 | 0.5-2 |
| Rubber Seed Oil | 8-9 | 5.5-12 | 20-40 | 35-40 | 15-20 |
| Safflower Oil | 3-9 | 1-4 | 13-21 | 73-79 | |
| Sal Seed Oil | 4-9 | 35-50 | 35-45 | 1-4 | |
| Sesame Oil | 7-9 | 4-6 | 38-50 | 35-48 | |
| Sorghum Oil | 6-20 | 3-6 | 30-50 | 25-55 | 0.5-3 |
| Soybean Oil | 7-11 | 2-6 | 22-34 | 43-56 | 5-11 |
| Sunflower Oil | 3-6 | 1-6 | 14-35 | 44-75 | |
| Tamanu Oil | 14-19 | 6-10 | 35-55 | 15-30 | |
| Tea Seed Oil | 15-20 | 1.5-3 | 36-80 | 5-22 | 0-2 |
| Thumba Seed Oil | 10-15 | 7-10 | 20-28 | 50-60 | |
| Tobacco Seed Oil | 7-10 | 4-8 | 12-20 | 50-75 | |
| Wheat Germ Oil | 10-17 | 1-6 | 8-30 | 45-65 | 4-10 |

In one embodiment, a liquid solvent 50 is added during grinding S2 to the grinder 40 with the base material 20. The solvent may take the form of a mildly acidic aqueous solution with pH of between about 4.5 to 6.9, a neutral aqueous solution or a mildly alkaline solution with pH of between about 7.1 to 9.0. The solvent may also be a mixture of aqueous and organic components including hexanes, benzenes, toluene, ethanol, methanol or other alcohols. One example of a solvent is water heated to a temperature of between about 60° C. to 90° C. In another example, in water, between about 80° C. and 83° C. with a pH of between about 6.8 to 7.2. The pH promotes stability so that the protein stays in solution. Plant proteins become unstable in acidic solutions.

In one embodiment, the homogenous liquid slurry from the grinder 40 is added to mixer 70 and alpha-amylase, pectase, or other enzymes 60 are also added to the mixer 70. The temperature of the liquid slurry is between about 40° C. and 50° C. and the final concentration of each added enzyme is between about 25 and 100 μg/mL. The enzymes promote breakdown of starches into digestible carbohydrates.

The liquid slurry 40 and enzymes 60 are mixed in a mixer 70 with gentle agitation, preferably between about 15 to 200 rpm, at a temperature between about 40° C. to 60° C. for between about 5 to 20 minutes. In one example, about 10 minutes. Subsequently, the temperature of the liquid slurry is raised to between about 70° C. and 75° C. for between about 10 and 20 minutes to facilitate solubilization.

After enzymatic treatment 80, the remaining insoluble components are removed from the liquid slurry by filtration or centrifugation. In one example of the method, the slurry is strained in step S8 through a mesh screen or filter with a pore size of between about 10 to 100 μM before it is added to a processor 100.

Additives 90 such as vitamins, flavorings, sweeteners, emulsifiers or other stabilizers can be added in combination or separately to the liquid after filtration in step S8 through the filter 80. Addition of vitamins serves to fortify the nutritional profile of the liquid product and may include vitamins A, B₁, B₂, B₆, B₁₂, C, D, E, K, minerals such as calcium, chloride, magnesium, phosphorous, potassium, sodium, and other nutrients comprising beta-carotene, biotin, folic acid, niacin, and pantothenic acid. In one embodiment, about ˜0.5% by weight of the resulting composition is vitamins.

Addition of artificial or natural flavorings serves to improve the taste of the liquid product by masking or complementing the bitter nutty or beany components of the source plant base material. Examples of useful flavor additives include chocolate and vanilla. Addition of sweeteners can further improve the taste for oral consumption. The range of additive 90 sweeteners can comprise between about 0.5% and 15% by weight of the final composition and examples of sweeteners include liquid or crystalline sugar, agave, cane juice, honey, sucralose, aspartame, saccharine, or other natural or artificial sweeteners. Emulsifiers and other stabilizers such as starches, gums, hydrocolloids, including but not limited to guar gum, acacia, carrageenan, cellulose, gellan, locust bean, pectin, sunflower lecithin, and xanthan can be added to control the viscosity and texture of the liquid product. In one embodiment, guar gum and sunflower lecithin are used in a range of between about 0.005% and 0.5% by weight of the final composition at a ratio of 1:1 guar gum to sunflower lecithin. In one embodiment, the resulting composition has a viscosity of about 0.0015 to 0.0025 Pa s at room temperature 25° C.

After passing through the filter 80, the filtered liquid can be combined with additives 90 with mixing and may be heated to facilitate dissolution of the additives 90. A processor 100 can be used to achieved, for example, by heating the mixture to between about 30 and 40° C. and blending with immersion at a rate of between about 1000 and 15000 rpm.

The end liquid mixture product 110 removed from the processor 100 in some embodiments has a composition of between about 2.5% and 7% by weight of plant derived fats; from between about 1% and 10% by weight plant derived carbohydrates; and from between about 0.025% and 7% by weight of plant derived proteins. One example liquid mixture product 110 removed from the processor 100 has a composition of about 2.5%, 2.6%, 2.7%, 2.8%, 2.9%, 3%, 3.1%, 3.2%, 3.3%, 3.4%, 3.5%, 3.6%, 3.7%, 3.8%, 3.9%, 4%, 4.1%, 4.2%, 4.3%, 4.4%, 4.5%, 4.6%, 4.7%, 4.8%, 4.9%, 5%, 5.1%, 5.2%, 5.3%, 5.4%, 5.5%, 5.6%, 5.7%, 5.8%, 5.9%, 6%, 6.1%, 6.2%, 6.3%, 6.4%, 6.5%, 6.6%, 6.7%, 6.8%, 6.9%, or 7% by weight of plant derived fats; from about 1%, 2%, 3%, 4%, 5%, 6%, 7%, 8%, 9%, or 10% by weight plant derived carbohydrates; and about 0.025%, 0.050%, 0.1%, 0.5%, 1%, 1.25%, 1.5%, 1.75%, 2%, 2.25%, 2.5%, 2.75%, 3%, 3.25%, 3.5%, 3.75%, 4%, 4.25%, 4.5%, 4.75%, 5%, 5.5%, 6%, 6.5%, or 7% by weight of plant derived proteins.

Specifically, the component of plant derived fats can consist of between about 60% and 90% by volume long chain fatty acids and between about 10% and 40% by volume of medium chain fatty acids. In one embodiment, the plant derived fats can consist of about 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 98%, 89%, or 90% long chain fatty acids. In one embodiment, the plant derived fats can consist of about 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, or 40% medium chain fatty acids.

In one embodiment, this composition 110 more closely approximates the composition found in dairy milk than other plant-based milk alternatives and mimics the functional characteristics of dairy milk, such as, aeration, thermodynamic, tensile, and surfactant properties.

Examples of specific dairy milk properties include: a viscosity of about 0.002 Pa s (pascal-second) at 20° C., 0.003 Pa s at 4° C., and 0.0005 at 80° C.; a moisturization of about 87% water by weight; and a freezing point of about −0.5° C.

These functional characteristics are desirable in preparing foams and creams or other baking, cooking, and beverage applications as a substitute for dairy milk. The composition 110 may be subsequently diverted to deaerating, homogenizing, pasteurizing, filling, bottling, or packaging components to suitably prepare 110 for commercial sale or use.

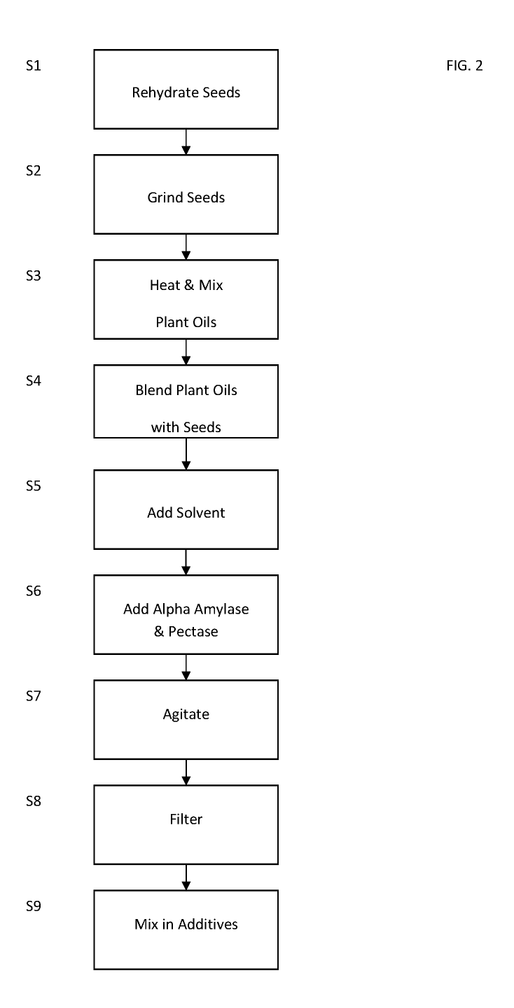

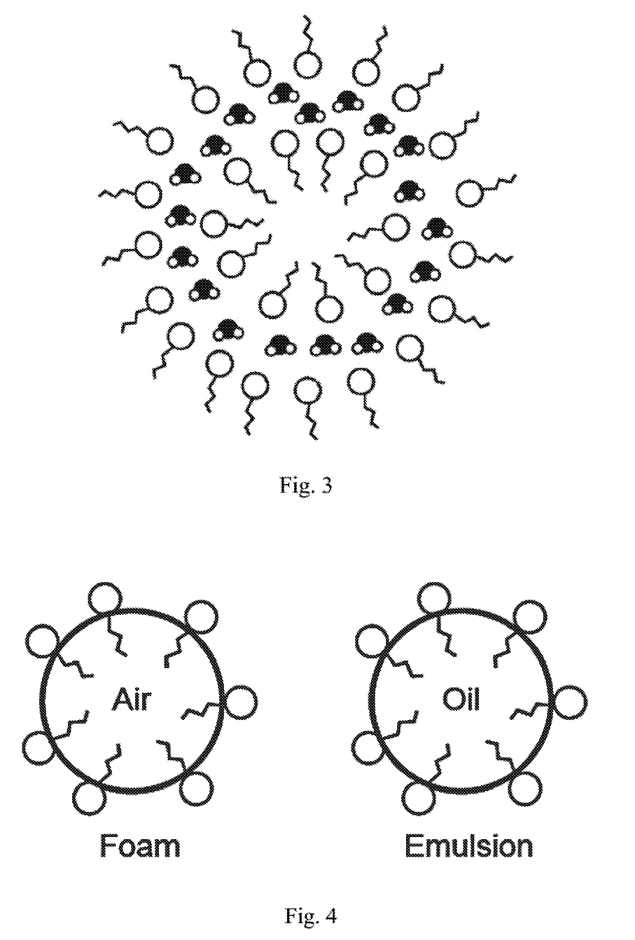

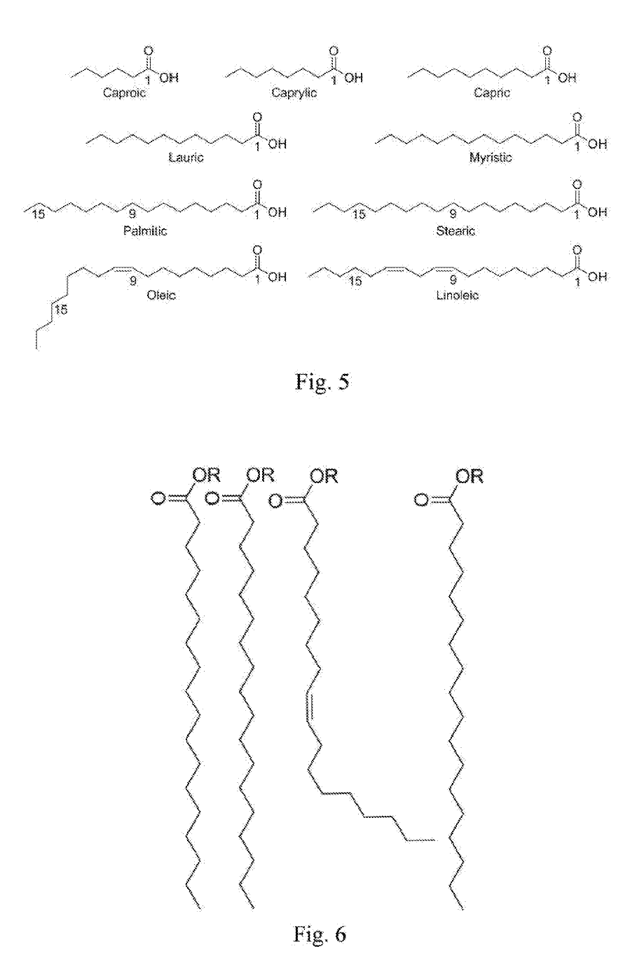

As shown in the method of FIG. 2, S1 comprises rehydrating seeds or plant-based materials. In one example, dried chickpeas are rehydrated for about 6 to 8 hours in a solution of between about 15° C. to 25° C. water and between about 0.1 and 0.15 molar sodium bicarbonate. In one embodiment, the method comprises grinding or blending S2 the seeds or plant-based materials 20 in a grinder or blending machine 40. S3 comprises heating crude and refined plant oils 30 to a temperature of between about 30° C. to 50° C. and mixed by gentle stirring at between about 50 to 500 rpm. In one example, the refined plant oils comprise about 1 part by weight of refined palm oil or refined palm kernel oil combined with about 1 part by weight of virgin coconut oil.

Step S4 comprises adding the seed or nut material 20 to a grinder or blender 40 to produce a roughly milled powder or, alternatively, when combined with solvent 50, a homogenous slurry. In one example, S4 comprises blending the seed or nut material 20 with a spinning metal blade at a rate of between about 1500 and 25000 rpm inside a closed chamber. One example of S4 further comprises adding blended oils 30 prior or during dissociation and the final resulting mixture being between about 20% to 30% seed or nut material 20, between about 2% to 10% blended oils 30, and between about 60% to 80% solvent 50 by volume.

In one example of the method, in S5, a liquid solvent 50 is added to blender 40 with the plant or nut material 20. The solvent can be a mildly acidic aqueous solution with pH of between about 4.5 and 6.9, a neutral aqueous solution or a mildly alkaline solution with pH of between about 7.1 and 9.0. The solvent can also be a mixture of aqueous and organic components including hexanes, benzenes, toluene, ethanol, methanol, or other alcohols. In one example of S5, the solvent is water and is heated to a temperature of between about 60 and 90° C. or, in another example, between about 80 and 83° C., with a pH of between about 6.8 and 7.2.

In one example of the method, S6 comprises adding the resulting homogenous liquid slurry 60 from blender 40 to mixer 70 and adding alpha-amylase and pectase to mixer 70. In one example, the temperature of the liquid slurry is between about 40 to 50° C. and the final concentration of each added enzyme is between about 25 to 100 μg/mL.

In one example of the method, in S7 the liquid slurry in the blender 40 and enzymes 60 added in S6 are mixed with gentle agitation. In one example between about 15 and 200 rpm, at a temperature between about 40 and 60° C. for between about 5 to 20 minutes. In other example it is mixed for about 10 minutes. In one example of the method, the temperature of the liquid slurry is subsequently raised to between about 70 to 75° C. for between about 10 and 20 minutes to facilitate solubilization.

In one example of the method, an additional step S8 is performed following enzymatic treatment of the liquid slurry, comprising removing the remaining insoluble components from the liquid slurry using a filter or centrifuge 80. In one example of S8, the slurry is strained through a mesh screen with a pore size of between about 10 to 100 μM.

In one example of the method, and additional step occurs comprising optionally adding additives 90 such as vitamins, flavorings, sweeteners, emulsifiers or other stabilizers in combination or separately to the filtered liquid following S8, fortifying the nutritional profile of the liquid product as described above. In one example, S8 further comprises the additional step of improving the taste of the liquid product by adding artificial or natural flavorings as described above. In one example, sweeteners are added in amounts to comprise between about 0.5% and 15% by weight of the final composition. In one example, emulsifiers and stabilizers are added in amounts to comprise between about 0.005% and 2% by weight of the final composition. In one embodiment, guar gum is the emulsifier. In another embodiment, sunflower lecithin is the emulsifier. In one embodiment, guar gum and sunflower lecithin are used together as emulsifiers. In one embodiment, lecithin from another source is used as an emulsifier or together with guar gum. Examples of sweeteners, emulsifiers and stabilizers are provided above and can provide the additional step to S9 of controlling the viscosity and texture of the liquid product in a range from between about 0.005% to 2% by weight of the final composition.

In one example of the method, an optional step comprises combining in a food processor 100 the filtered liquid product 110 from the filter or centrifuge 80 with additives 90 and mixing to facilitate dissolution of the additives 90. Optionally, heating can facilitate dissolution of the food processor 100, for example, by heating the mixture to between about 30 and 40° C. and blending with immersion at a rate of between about 1000 and 15000 rpm.

Optionally, the method can be confirmed by testing the end liquid product 110 for a composition of between about 2.5% and 7% by weight of plant-based fats; from between about 1% and 10% by weight of plant-based carbohydrates; and from between about 0.025% and 7% by weight of plant-based proteins. In one embodiment, the method can be confirmed by testing the liquid end product 110 for a composition of between about 0.5% and 1.0% lauric acid by weight, and in one embodiment, about 0.7% lauric acid by weight. In one embodiment, the method can be confirmed by testing the liquid end product 110 for a composition of between about 0.15% and 0.45% myristic acid by weight, and in one embodiment, about 0.3% myristic acid by weight. In one embodiment, the method can be confirmed by testing the liquid end product 110 for a composition of between about 0.5% and 0.95% palmitic acid by weight, and in one embodiment, about 0.7% palmitic acid by weight. In one embodiment, the method can be confirmed by testing the liquid end product 110 for a composition of between about 0.05% and 0.3% stearic acid by weight, and in one embodiment, about 0.15% stearic acid by weight. In one embodiment, the method can be confirmed by testing the liquid end product 110 for a composition of between about 0.5% and 1.1% unsaturated fatty acid by weight, and in one embodiment, about 0.8% unsaturated fatty acid by weight. In one embodiment, the method can be confirmed by testing the liquid end product 110 for a composition of between about 1.8% and 2.2% saturated fatty acid by weight, and in one embodiment, about 2% saturated fatty acid by weight. In one embodiment, the method can be confirmed by testing the liquid end product 110 for a composition of between about 1.2% and 1.7% palm oil by weight, and in one embodiment, about 1.5% palm oil by weight. In one embodiment, the method can be confirmed by testing the liquid end product 110 for a composition of between about 1.2% and 1.7% coconut oil by weight, and in one embodiment, about 1.5% coconut oil by weight. In one embodiment, the method can be confirmed by testing the liquid end product 110 for a composition of between about 1.5% and 2.0% long chain fatty acid by weight, and in one embodiment, about 1.75% long chain fatty acid by weight. In one embodiment, the method can be confirmed by testing the liquid end product 110 for a composition of between about 1% and 1.5% medium chain fatty acid by weight, and in one embodiment, about 1.2% medium chain fatty acid by weight. In one example the method can include an optional step to confirm fatty acid composition by testing the end liquid product 110 for a fatty acid profile having a ratio of between about 60% and 90% long chain fatty acids and between about 10% and 40% medium chain fatty acids.

Optionally, the method can further comprise deaerating, homogenizing, pasteurizing, filling, bottling, or packaging the end product 110 for commercial sale or use.

### Example I

### Making Milk Substitute from Chickpeas with Plant-Based Oil Additives

One example of an embodiment of the invention produced by the method of this disclosure can be prepared by grinding about 1 part rehydrated whole chickpeas with about 3 parts water at a temperature greater than about 60° Celsius to yield an aqueous suspension of protein and carbohydrates. Simultaneously or subsequently a mixture of fatty acids is added that is prepared by combining about equal parts of coconut oil and palm oil to achieve a ratio of about 35 parts medium chain fatty acids (blended oils) to about 65 parts long chain fatty acids. The mixture is added with agitation to yield a stable emulsion and maintained at a temperature greater than about 50° Celsius to facilitate solubility of proteins, carbohydrates, and fatty acids for between about 1 and 15 minutes. In this example, the mixture of added fatty acids is added in about 1/32 equivalents to about 1 equivalents of the aqueous suspension to yield a composition similar to dairy milk. The resulting emulsion is then treated with amylase and pectase for between about 5 and 10 minutes to enzymatically hydrolyze polymeric starches into soluble carbohydrates. After enzymatic treatment the aqueous suspension is heated above about 60° C. and any remaining insoluble particulates greater than about 300 microns are removed by size exclusion filtration. The resulting liquid composition can then be pasteurized and used as a plant-based milk alternative base for food and beverage products.

### Example II

Making Milk Substitute from Chickpea Protein Isolate with Plant-Based Oil Additives

A second example can be prepared by blending chickpea protein isolate (or other protein isolated from other non-fat plant materials) with carbohydrates in water and adding palm and coconut oil with sufficient agitation to produce a stable emulsion according to formulation as described in Table 7. In one embodiment, the oils are evenly dispersed throughout the solution without separating into aqueous and non-aqueous layers. In one embodiment, the source of the protein isolate varies but comprises polymeric chains of glucose that are maltodextrose chains with a length between about 10 and 20 Dextrose Equivalents (“DE”).

TABLE 7

| Components | Grams |
|---|---|
| Chickpea protein isolate | 7 |
| Palm oil | 2.5 |
| Coconut oil | 2.5 |
| Maltodextrin | 18 |
| Water | 235 |

### Example III

Adding Stabilizers to Chickpea Based Milk Substitute

Another example of the method includes supplementing either of the previously described examples with less than about 1% by weight with sunflower lecithin and less than about 1% by weight of guar gum or other emulsifiers or stabilizers. The ratios must be kept low enough that they provide the viscosity of milk but do not alter the flavor of the product.

### Example IV

Making Frozen Dessert

TABLE 8
Ice Cream Style Formulation

| Ingredient | Amount (g per 100 g) |
|---|---|
| Water | 63 |
| Sugar | 15 |
| Nonfat plant milk solids | 11.5 |
| Fat | 10 |
| Emulsifier and stabilizer | 0.5 |

TABLE 9
Gelato Style Formulation

| Ingredient | Amount (g per 100 g) |
|---|---|
| Water | 67 |
| Sugar | 15 |
| Nonfat plant milk solids | 11.5 |
| Fat | 6 |
| Emulsifier and stabilizer | 0.5 |

Typical ingredients for ice cream and gelato are shown in Table 8 and 9, respectively. Typical ice cream liquid mixes have a fat globule size of 0.7 μM, a density of 1.1 g/mL, a specific heat of 3.3 kJ/kg ° C., and a viscosity of 0.4 Pa s at 4° C. Once set and hardened at −15° C. the ice cream has an average ice crystal size of 30 μM, an average air cell size of 15 μM, and about 65% of water content is frozen. A plant-based liquid composition of the present disclosure is combined with sugar, emulsifier and stabilizers as specified in Table 8 and Table 9 and mixed until dry ingredients are fully dissolved and until a stable colloidal mixture is obtained. Alternatively, dry ingredients may be liquified prior to addition. The temperature during mixing is between about 25° C. to 65° C. utilizing high shear mixers or powder funnels. The resulting mix is pasteurized using a batch or continuous process heating to between about 69° C. to 250° C. for between about 0.1 to 30 minutes dependent upon the method of pasteurization utilized (low temperature long time, high temperature short time, or ultra-high temperature) and subsequently diverted to a homogenizer. The mix is then cooled to between 1° C. and 5° C. and held for between 4 to 24 hours. Flavorings are then added and mixed in with sufficient agitation. The mix is then passed to a freezing unit with a spinning dasher. Air is injected and incorporated into the mix via rotary action of the dasher until suitable overrun is achieved. The mixture is then drawn and filled into packaging and placed into −15° C. freezers to harden.

The mixture prior to freezing has a fat globule size of 0.5-1.0 μM, a density of between about 1.05 to 1.15 g/mL, a specific heat of between about 3.2 and 3.5 kJ/kg ° C., and a viscosity of between about 0.1 and 0.8 Pa s at 4° C. After hardening at −15° C. the frozen mixture has an average ice crystal size of between about 20 to 50 μM, an average air cell size of between about 20 to 30 μM and between about 50 to 80% of water.

### Example V

Making Milk Chocolate

TABLE 10
Milk Chocolate Style Formulation

| Ingredient | Amount (g per 100 g) |
|---|---|
| Cocoa mass | 20 |
| Cocoa butter | 17 |
| Plant milk powder | 20 |
| Sugar | 42.5 |
| Lecithin | 0.5 |

Ingredients typical to milk chocolate are shown in Table 10. Typical milk chocolate has a particle size of 30 μM and a Casson viscosity of about 1.5 Pa s at 40° C. Additionally, the percent of solid milk fats at room temperature is about 15% by weight.

Cocoa mass and cocoa butter are combined with mixing and heated to a temperature of 35° C. or higher to form a liquid mixture. Sugar, a dehydrated plant-based liquid composition of the present disclosure, and lecithin are added with mixing or agitation until dissolved and optionally grinded using a melangeur pan or equivalent to form a liquid paste which is then passed onto a rolling refiner or grinder and milled until an average particle size of approximately 30 μM is achieved while maintaining a temperature of 35° C. or higher. The resulting mixture is then transferred to conche system to remove volatiles and moisture with constant agitation and heating from between 35° C. to 80° C. for a least about 3 to about 12 hours. The mixture is then dispensed in molds and cooled to 25° C. or below until solidified.

The resulting chocolate has an average particle size of 20-45 μM and a Casson viscosity of between about 1.3 to 1.6 Pa s at 40° C. The percent of solid non-cocoa butter fats is between 10% and 20% at room temperature. In other words, the resulting chocolate is not readily distinguishable from milk chocolate.

In one example of the method, manufacturing comprises the steps of: grinding 1 part plant-based material from seeds or nuts; adding 3 parts water; making a plant oil mixture by heating and mixing equal parts by weight of palm oil and coconut oil to a temperature of between about 30 and 50° C.; blending ⅛ part of the plant oil mixture with the plant-based material and the water; adding alpha-amylase to a final concentration of between about 25 to 100 μg/mL; adding pectase to a final concentration of between about 25 to 100 μg/mL; agitating the composition between about 15 and 200 rpm at a temperature between about 40° C. and 60° C. for about 10 minutes; and removing any remaining insoluble components from the composition using a filter having a pore size of between about 10 and 100 μM, wherein the composition is a plant-based liquid dairy milk substitute composition. In one example, the method further comprises adding equal parts guar gum and sunflower lecithin to between about 0.005% and 0.5% by weight of the plant-based liquid composition. In one example, the plant-based seeds used in the method are chickpeas. In one example, the resulting plant-based liquid composition is between about 84% to 90% water by weight, 3% to 5% plant-based fatty acids by weight, 1 to 10% plant-based carbohydrates by weight, and 2.5% to 5% plant-based protein by weight. In one example, the method further comprises dehydrating the plant-based liquid composition. In one example, the resulting plant-based liquid composition has a ratio of unsaturated fatty acids to saturated fatty acids of between about 1:1.5 to 1:2.5. In one example, the resulting plant-based liquid composition has a ratio of medium chain fatty acids to long chain fatty acids of between about 1:1.25 to 1:4 In one example, the resulting plant-based liquid composition is further comprised of between about 1.5% to 2.5% saturated fatty acids by weight. In one example, the resulting plant-based liquid composition is further comprised of between about 0.5% to 1% unsaturated fatty acids by weight. In one example, the resulting plant-based liquid composition is dehydrated and used as a dairy substitute in chocolate. In one example, the plant-based liquid composition is used as a dairy substitute in frozen dessert.

In the foregoing description, it will be readily appreciated by those skilled in the art that modifications may be made to the invention without departing from the concepts disclosed herein. Such modifications are to be considered as included in the following claims, unless the claims by their language expressly state otherwise.

What is claimed is:

1. A composition comprising:
between about 84% and 90% by weight water;
between about 3% and 5% by weight plant-based fatty acids;
between about 1% to 10% by weight plant-based carbohydrates; and
between about 2.5% to 5% by weight plant-based proteins,
wherein the composition is a plant-based liquid dairy milk substitute composition.

2. The plant-based fatty acids of claim 1 further comprising a mixture of between about 10% and 40% medium chain fatty acids and between about 60% and 90% long-chain fatty acids.

3. The plant-based fatty acids of claim 1, further comprising medium chain fatty acids and long chain fatty acids in a ratio of medium chain fatty acids to long chain fatty acids of between about 1:1.25 to 1:4.

4. The plant-based fatty acids of claim 1, further comprising medium chain fatty acids and long chain fatty acids, the medium chain fatty acids further comprising between about 1% to 1.5% by weight of the liquid plant-based composition and the long chain fatty acids further comprising between about 1.5% to 2.0% by weight of the liquid plant-based composition.

5. The plant-based fatty acids of claim 1, further comprising unsaturated fatty acids and saturated fatty acids in a ratio of unsaturated fatty acids to saturated fatty acids of between about 1:1.5 to 1:2.5.

6. The plant-based fatty acids of claim 1, further comprising unsaturated fatty acids and saturated fatty acids, the unsaturated fatty acids further comprising between about 0.5% to 1.0% by weight of the liquid plant-based composition and the saturated fatty acids further comprising between about 1.5% to 2.5% by weight of the liquid plant-based composition.

7. The plant-based fatty acids of claim 2, further comprising equal parts palm oil and coconut oil.

8. The composition of claim 1, wherein the protein is derived from chickpeas.

9. The composition of claim 2, wherein the plant-based medium chain fatty acids comprise lauric and myristic acids.

10. The composition of claim 2, wherein the plant-based long chain fatty acids comprise palmitic and stearic acids.

11. A method of manufacturing a composition comprising the steps of:
grinding 1 part plant-based material from seeds or nuts;
adding 3 parts water;
making a plant oil mixture by heating and mixing equal parts by weight of palm oil and coconut oil to a temperature of between about 30 and 50° C.;
blending ⅛ part of the plant oil mixture with the plant-based material and the water;
adding alpha-amylase to a final concentration of between about 25 to 100 μg/mL;
adding pectase to a final concentration of between about 25 to 100 μg/mL;
agitating the composition between about 15 and 200 rpm at a temperature between about 40° C. and 60° C. for about 10 minutes; and
removing any remaining insoluble components from the composition using a filter having a pore size of between about 10 and 100 μM,
wherein the composition is a plant-based liquid dairy milk substitute composition.

12. The method of claim 11, further comprising: adding equal parts guar gum and sunflower lecithin to between about 0.005% and 0.5% by weight of the plant-based liquid composition.

13. The method of claim 11, wherein the plant-based seeds are chickpeas.

14. The method of claim 11, wherein the plant-based liquid composition is between about 84% to 90% water by weight, 3% to 5% plant-based fatty acids by weight, 1 to 10% plant-based carbohydrates by weight, and 2.5% to 5% plant-based protein by weight.

15. The method of claim 12, further comprising dehydrating the plant-based liquid composition.

16. The method of claim 11, wherein the plant-based liquid composition has a ratio of unsaturated fatty acids to saturated fatty acids of between about 1:1.5 to 1:2.5.

17. The method of claim 11, wherein the plant-based liquid composition has a ratio of medium chain fatty acids to long chain fatty acids of between about 1:1.25 to 1:4.

18. The method of claim 11, wherein the plant-based liquid composition is further comprised of between about 1.5% to 2.5% saturated fatty acids by weight.

19. The method of claim 11, wherein the plant-based liquid composition is further comprised of between about 0.5% to 1% unsaturated fatty acids by weight.

20. The method of claim 15, wherein the dehydrated plant-based liquid composition is used as a dairy substitute in chocolate.

21. The method of claim 12, wherein the plant-based liquid composition is used as a dairy substitute in frozen dessert.
